(19) United States
(12) Patent Application Publication
(10) Pub. No.: US 2011/0087404 A1
(43) Pub. Date: Apr. 14, 2011

(54) Method for Operating A Control Device of A Motor Vehicle and Control Device of A Motor Vehicle for Carrying Out The Method

(75) Inventors: Stephan Cieler, Frankfurt (DE); Ralf Lenninger, Wuerzburg (DE); Guido Meier-Arendt, Langen (DE); Winfried Möll, Laubach (DE)

(73) Assignee: Continental Automotive GmbH, Hannover (DE)

(21) Appl. No.: 12/999,886

(22) PCT Filed: Jun. 3, 2009
(86) PCT No.: PCT/EP2009/056805

§ 371 Date: Dec. 17, 2010

(30) Foreign Application Priority Data
Jun. 17, 2008 (DE) 10 2008 028 424.6

(51) Int. Cl. G06F 7/00; B60G 17/015

(52) U.S. Cl. 701/37; 701/1

(57) ABSTRACT

A system for actuating a passenger compartment control device of a force-transmitting device and a chassis control device of a motor vehicle, various functions of the devices are combined to form functional classes. The devices can be actuated simultaneously by a first selection of the functional classes.

### PRIORITY CLAIM

This is a U.S. national stage of application Ser. No. PCT/EP2009/056805, filed on Jun. 3, 2009, which claims priority to German Application No: 10 2008 028 424.6, filed: Jun. 17, 2008, the contents of which are incorporated herein by reference.

### BACKGROUND OF THE INVENTION

1. Field of the Invention

The invention relates to a method for operating a control unit of a motor vehicle for activating units, such as an interior control unit, a power transmission unit, and a chassis control unit, having a central operating element for selecting functions of the units. The invention furthermore relates to a control unit of a motor vehicle for carrying out the method for activating units such as an interior control unit, a power transmission unit, and a chassis control unit, having a central operating element for selecting functions of the units.

2. Related Art

Modern motor vehicles have a large number of units, on which different demands are made by different drivers and in different driving situations. Activating each of the various units with a separate control unit and dedicated operating elements has proven very complex and confusing for the driver of the motor vehicle.

A motor vehicle in which a control unit is provided with a single operating element for activating the various units has therefore become known in practice. With this, the desired unit can be activated in a first selection, and the function of the respective units can be selected in a second selection. However, this likewise leads to various units being complex to operate.

### SUMMARY OF THE INVENTION

One embodiment of the invention is to develop a method of the type stated at the outset in such that it allows particularly simple activation of the various units. Moreover, the intention is to provide a control unit of particularly simple construction for carrying out the method.

According to one embodiment of the invention, the first-mentioned problem is solved by the fact that respective functions of all three units mentioned are grouped into individual function classes, and that the functions of the function classes are assigned different basic settings, and that, in an initial selection, the function classes are selected by the operating element.

By this configuration, the method according to one embodiment of the invention allows simultaneous activation of all three units mentioned through one-time actuation of the operating element. It is appropriate that the function classes should be designed for various requirements, and that the functions of the three units mentioned should be assigned to basic settings corresponding to the requirements. It will thereby be possible to generate different function classes for a holiday trip or a sporty mountain drive, for example, these simply being selected by the driver in the corresponding driving situation. Both the power transmission unit, such as the engine controller and an automatic transmission system, the chassis control unit including the suspension settings and the ground clearance of the motor vehicle, and the interior control unit including the lighting, the air conditioning system, the radio and various display units are then switched to the basic settings specified for the function classes. For this purpose, it is sufficient, according to the invention, for the function class simply to be selected by the driver of the motor vehicle.

According to another advantageous development of the invention, the individual functions of the function classes can simply be activated individually if, after the initial selection of the function classes by the operating element, the individual functions of the function classes can be activated in a second selection. By virtue of this configuration, it is possible for the basic settings of the individual functions to be changed and adapted to the individual units to the individual specifications of the driver.

A simple one-time actuation of the operating element allows the motor vehicle to be operated in a particularly economical manner if, in one of the function classes, a reduced engine power, a high transmission ratio, a hard setting of the chassis of the motor vehicle, and a shutdown of a compressor of an air conditioning system are assigned as basic settings. In addition, large-format display units and their background illumination can be deactivated. A function class of this kind can be characterized as economical in the control unit. In an alternative embodiment, a high engine power and a transmission ratio adjusted to a sporty setting can be stored as a further function class, which is characterized as sporty.

According to one embodiment of the invention, inadvertent operation of the motor vehicle at a high fuel consumption can be avoided in a simple manner if an indication for the driver of the motor vehicle is displayed if he leaves an economically optimized function class. It is preferable if the change between function classes is also coupled with an active inquiry to the driver as to whether the change is really desired.

One-time actuation of the operating element makes the motor vehicle particularly convenient to operate, especially for older people if, in one of the function classes, a particularly narrow range of functions, a particularly soft setting of the chassis and a reduction in the maximum engine speed are assigned as basic settings.

A function class of this kind can be stored as a comfort setting in the control unit.

If the motor vehicle is operated by different drivers, an extensive profile can be activated simply by one-time actuation of the operating element if, in one of the function classes, basic settings adjusted to the individual driver are assigned for all of the units mentioned. It is thereby possible to generate in the control unit a specific driver profile that can be selected on an individual basis by the driver. It is preferable if it is thereby also possible to determine the position of the steering wheel and the driver's seat by way of the interior control unit.

According to one embodiment of the invention, complex programming of the control unit can be avoided in a simple manner if the control unit determines a driver profile from actions of the driver and, from the driver profile, sets up a function class corresponding to the individual driver.

When the motor vehicle is used by different drivers, it is possible, according to another advantageous development of the invention, for the function class adapted specifically to the respective driver to be selected in a simple manner if the control unit is connected to a detection device for determining biometric data for identifying the driver.

According to another advantageous development of the invention, the operation of the control unit of the motor vehicle can be further simplified if an image on a display unit for displaying information in the motor vehicle is switched over in accordance with the function classes selected. By virtue of this configuration, it is possible, for example, to compile a particularly convenient function class for older drivers of the motor vehicle, in which class a large-format representation of information is generated on the display unit, and the chassis is simultaneously set to comfortable springing and an automatic transmission is set to early upshifts. Moreover, this makes it possible to represent a sportily or ecologically oriented function class visually for the driver too, in a basic setting of the display unit.

The second problem mentioned, namely the provision of a control unit of particularly simple construction for carrying out the method, is solved, according to the invention, by the fact that a plurality of functions of the three units mentioned are grouped into function classes, that the function classes have different basic settings of the functions of the various units, and that, in an initial position, the operating element is designed to select function classes.

### BRIEF DESCRIPTION OF DRAWINGS

The invention admits of numerous embodiments. To further clarify the basic principle thereof, one of these is illustrated in the drawings and is explained below. In the drawings:

FIG. 1 is a motor vehicle with various units and a control unit for activating the units;

FIG. 2 is a, schematic circuit diagram of the control unit with the various units from FIG. 1; and

FIG. 3 is a flow diagram of a method for activating the control unit in FIG. 1.

### DETAILED DESCRIPTION OF THE DRAWINGS

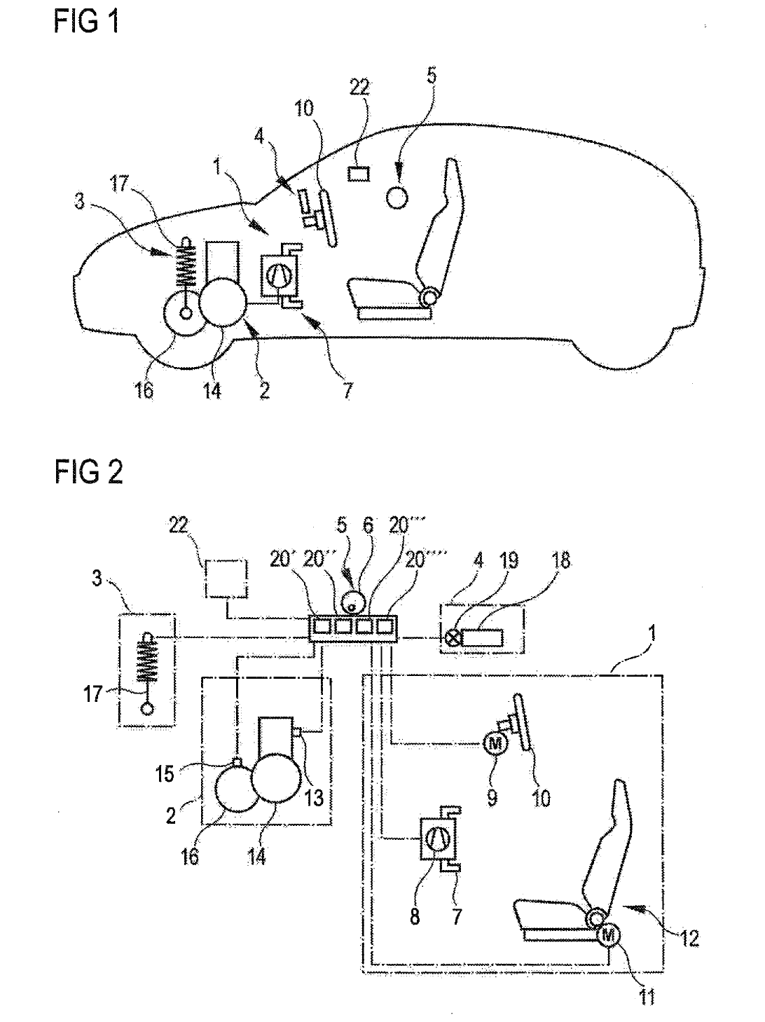

FIG. 1 schematically shows a motor vehicle with various units, such as an interior control unit 1, a power transmission unit 2, a chassis control unit 3, a display unit 4, and a control unit 5 for activating units 1-4. In an alternative embodiment (not shown), the display unit 4 can be part of the interior control unit 1.

FIG. 2 shows schematically a circuit diagram for activating the various units 1-4 by an operating element 6 of the control unit 5. The interior control unit 1 has an air conditioning system 7 with a compressor 8, an adjusting unit 9 for a steering wheel 10 and an adjusting unit 11 for a driver's seat 12. The power transmission unit 2 has an engine controller 13 for controlling the speed and an engine power of an internal combustion engine 14 of the motor vehicle, and a transmission control unit 15. The transmission control unit 15, activates a transmission 16 and, for example, to define the shift points thereof. A spring strut 17 is shown by way of example to illustrate the chassis control unit 3, by which strut it is possible to define the spring characteristics of the motor vehicle in accordance with the signals from the control unit 5. By way of example, the display unit 4 has a single display panel 18 with background illumination 19 for representing information. It is, of course, also possible for further display panels (not shown), image playback devices or the like to be arranged in the motor vehicle and to be activated as part of the display unit by the control unit.

Various basic settings of individual functions of the various units 1-4 are grouped into function classes 20′-20′″ in the control unit 5. By selecting one of the function classes 20′-20′″ by means of the operating element 6 it is thus possible to activate all the units 1-4 simultaneously.

FIGS. 1 and 2 furthermore show that a detection device 22, connected to the control unit 5, for detecting biometric data for identifying the driver is arranged in the motor vehicle. This makes it possible to store a plurality of function classes 20″″ adapted specifically to different drivers and to call them up after identification of the respective driver. The detection device 22 can be a device for detecting the fingerprint or the like, for example.

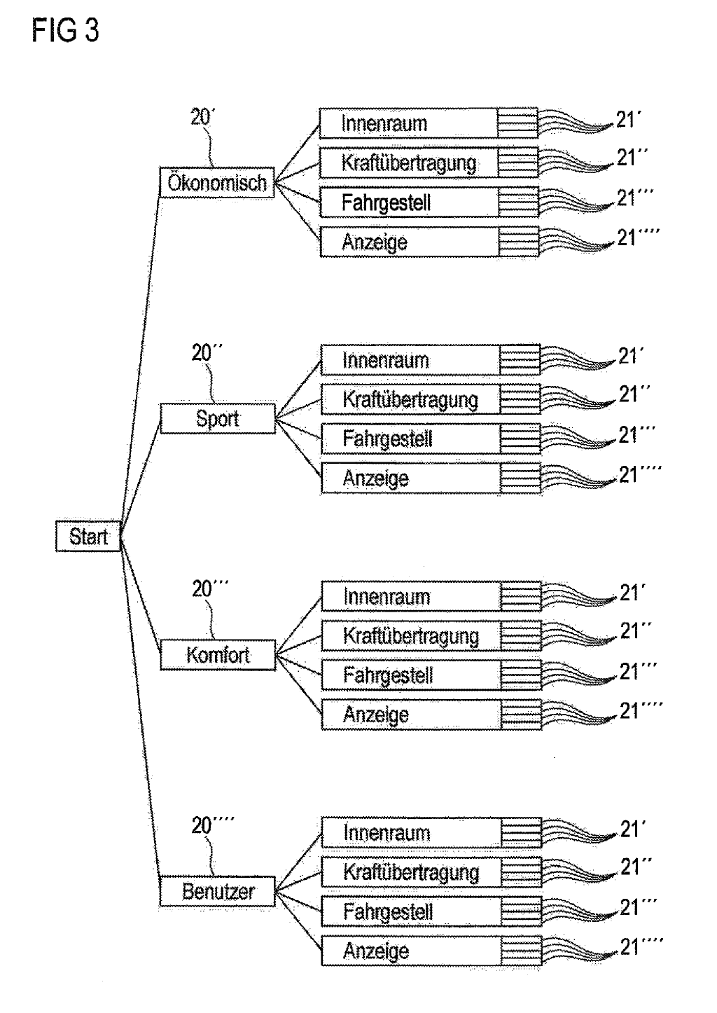

FIG. 3 is a flow diagram of the method for activating the control unit 5 in FIGS. 1 and 2. Beginning with a starting point, the various function classes 20′-20′″ designated as economy, sport, comfort and user by way of example can be activated in a first selection. By the selection, basic settings of functions 21′-21′″ of the various units 1-4 are activated. Functions 21′-21′″ can be modified individually if required in a second selection.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for operating a control unit of a motor vehicle comprising:
activating one or more of an interior control unit, a power transmission unit, and a chassis control unit;
selecting functions of the one or more units by a central operating element;
grouping respective functions of the one or more units into a plurality of individual function classes;
assigning different basic settings to the respective functions of the plural function classes; and
initially selecting one of the plural function classes by the operating element.

12. The method as claimed in claim 11, wherein after the initial selection of one of the plural function classes by the operating element, the individual functions of the function class can be activated in a second selection.

13. The method as claimed in claim 11, wherein, in one of the plural function classes, a reduced engine power, a high transmission ratio, a hard setting of a chassis of the motor vehicle, and a shutdown of a compressor of an air conditioning system are assigned as basic settings.

14. The method as claimed in claim 11, further comprising indicating by a display if a function class other than an economically optimized function class is selected.

15. The method as claimed claim 11, wherein one of the plural function classes provides a narrow range of functions, comprising a particularly soft setting of a chassis of the motor vehicle and a reduction in a maximum engine speed assigned as basic settings.

16. The method as claimed in claim 11, wherein, one of the plural function classes comprises basic settings adjusted to an individual driver that are assigned to the one or more units.

17. The method as claimed in claim 11, wherein the control unit determines a driver profile from actions of the driver and sets up a function class corresponding to the individual driver from the driver profile.

18. The method as claimed in claim 11, wherein the control unit is coupled to a detection device for determining biometric data for identifying the driver.

19. The method as claimed in claim 11, wherein an image on a display unit for displaying information in the motor vehicle is switched based at least in part on the function classes selected.

20. A control unit of a motor vehicle configured to:
activate one or more of an interior control unit, a power transmission unit, and a chassis control unit;
select functions of the one or more units by a central operating element;
group respective functions of the one or more units into a plurality of individual function classes;
assign different basic settings to the respective functions of the plural function classes; and
initially select one of the plural function classes by the operating element.

21. The method as claimed in claim 12, wherein, in one of the plural function classes, a reduced engine power, a high transmission ratio, a hard setting of a chassis of the motor vehicle, and a shutdown of a compressor of an air conditioning system are assigned as basic settings.

22. The method as claimed in claim 21, further comprising indicating by a display if a function class other than an economically optimized function class is selected.

23. The method as claimed claim 22, wherein one of the plural function classes provides a narrow range of functions, comprising a particularly soft setting of a chassis of the motor vehicle and a reduction in a maximum engine speed assigned as basic settings.

24. The method as claimed in claim 23, wherein one of the plural function classes comprises basic settings adjusted to an individual driver that are assigned to the one or more units.

25. The method as claimed in claim 23, wherein the control unit determines a driver profile from actions of the driver and sets up a function class corresponding to the individual driver from the driver profile.

26. The method as claimed in claim 25, wherein the control unit is coupled to a detection device for determining biometric data for identifying the driver.

27. The method as claimed in claim 26, wherein an image on a display unit for displaying information in the motor vehicle is switched based at least in part on the function classes selected.
